(19) United States
(12) Patent Application Publication
(10) Pub. No.: US 2026/0213086 A1
(43) Pub. Date: Jul. 23, 2026

(54) INSULATION ROD AND SWITCH

(71) Applicant: Mitsubishi Electric Corporation, Chiyoda-ku, Tokyo (JP)

(72) Inventors: Yusuke FUJIKI, Chiyoda-ku, Tokyo (JP); Kohei NAMBA, Chiyoda-ku, Tokyo (JP); Hiroshi TOTTORI, Chiyoda-ku, Tokyo (JP)

(73) Assignee: Mitsubishi Electric Corporation, Chiyoda-ku, Tokyo (JP)

(21) Appl. No.: 19/144,590

(22) PCT Filed: Mar. 15, 2023
(86) PCT No.: PCT/JP2023/009977

§ 371 Date: Jun. 30, 2025

(51) Int. Cl. H01H 3/38

(52) U.S. Cl. CPC H01H 3/38; H01H 2235/01

(57) ABSTRACT

An insulation rod includes: a spring receiver; a buried metal plate in the form of a bottomed cylinder in which the upper end is open, the buried metal plate accommodating the spring receiver so as to allow movement within a predetermined range along the inner peripheral surface of the buried metal plate; and an insulating portion that electrically insulates the outer peripheral surface of the buried metal plate. A bottom plate portion of the buried metal plate and a body portion of the buried metal plate are configured as separate bodies, and a compressed spring is provided between a lower surface of the spring receiver and the bottom plate portion of the buried metal plate.

### TECHNICAL FIELD

The present disclosure relates to an insulation rod and a switch.

### BACKGROUND ART

A typical insulation rod is a component that constitutes a high-voltage switch, and it has a function of insulating a main circuit, which is a high-voltage charged portion, from a grounded portion, a function of withstanding loads during the opening and closing operations of the switch, and, in a closed state of the switch, a function of applying contact pressure in the closing direction of the switch against a contact, thereby pressing the contact and reducing the contact resistance (see, for example, Patent Document 1).

In Patent Document 1, a flange portion that receives a contact pressure spring is provided on the buried metal plate of the insulation rod, and this flange portion bears the force of the spring during opening and closing.

### CITATION LIST

### Patent Document

Patent Document 1: Japanese Laid-Open Patent Publication No. H10-321089

### SUMMARY OF THE INVENTION

### Problem to be Solved by the Invention

In the insulation rod disclosed in Patent Document 1, during the opening operation of the switch, the load of the spring is received by the flange portion provided on the buried metal plate, and during the closing operation, the load is received by the bottom portion of the buried metal plate. However, when the opening and closing operations are repeated, the metal of the bottom portion of the buried metal plate peels off from the insulating portion that covers the buried metal plate, and the contact between the metal of the bottom portion of the buried metal plate and the insulating portion does not remain stable. In the vicinity of the bottom portion of the buried metal plate, the insulating portion wears due to the impact during the opening and closing of the switch, creating a minute gap that involves a risk of reduced electrical performance.

As a measure against this risk, because it is used in a low electric field, there is a method of ensuring an insulation distance by increasing the dimension between the buried metal plate and the grounded portion, or by measures such as applying conductive paint. However, this leads to increased production costs and worsened workability in production.

This disclosure is intended to disclose a technical solution to the above problems, and aims to provide an insulation rod and a switch that can be produced at low cost and with high workability during production.

### Means to Solve the Problem

An insulation rod disclosed in this disclosure includes: a spring receiver; a buried metal plate in the form of a bottomed cylinder with an open upper end, the buried metal plate accommodating the spring receiver so as to allow movement within a predetermined range along the inner peripheral surface of the buried metal plate; and an insulating portion that electrically insulates the outer peripheral surface of the buried metal plate. A bottom plate portion of the buried metal plate and a body portion of the buried metal plate are configured as separate bodies, and a compressed spring is provided between a lower surface of the spring receiver and the bottom plate portion of the buried metal plate.

An insulation rod disclosed in this disclosure includes: a spring receiver; a buried metal plate in the form of a bottomed cylinder with an open upper end, the buried metal plate accommodating the spring receiver so as to allow movement within a predetermined range along the inner peripheral surface of the buried metal plate; and an insulating portion that electrically insulates the outer peripheral surface of the buried metal plate. A plurality of compressed disc springs are provided between a lower surface of the spring receiver and an upper surface of the insulating portion that seals a lower end of an internal cavity of the buried metal plate, and the upper surface of the insulating portion includes a second recessed portion having the same shape as the disc springs when in an uncompressed state.

Additionally, A switch disclosed in this disclosure includes the insulation rod.

### Effect of the Invention

According to the insulation rod and the switch disclosed in this disclosure, it is possible to provide an insulation rod and a switch that can be produced at low cost and with high workability during production.

### BRIEF DESCRIPTION OF THE DRAWINGS

FIG. 1 is a schematic diagram showing the configuration of the main circuit portion of a switch according to Embodiment 1.

FIG. 2 FIG. 2A is a schematic cross-sectional view of the switch in the closed state according to Embodiment 1.

FIG. 2B is a schematic cross-sectional view of the switch at the moment the main contacts of the switch according to Embodiment 1 close or open.

FIG. 2C is a schematic cross-sectional view of the switch in the open state according to Embodiment 1.

FIG. 3 is a cross-sectional view of a principal part of the insulation rod according to Embodiment 1.

FIG. 4 is a schematic side view of the buried metal plate according to Embodiment 1.

FIG. 5A is a cross-sectional view of a principal part of the insulation rod in the closed state according to Embodiment 1.

FIG. 5B is a cross-sectional view of a principal part of the insulation rod in the open state according to Embodiment 1.

FIG. 6 is a cross-sectional view of a principal part of the insulation rod as a comparative example.

FIG. 7 is a cross-sectional view of a principal part of the insulation rod according to Embodiment 2.

FIG. 8 is a schematic side view of the buried metal plate according to Embodiment 2.

FIG. 9 is a cross-sectional view of a principal part of the insulation rod according to Embodiment 3.

### DESCRIPTION OF EMBODIMENTS

### Embodiment 1

An insulation rod and a switch according to Embodiment 1 will be described below with reference to the figures. In this specification, the axial direction Z is defined as the axial direction of the fixed conductive shaft and the movable conductive shaft to be described later, where the fixed contact side is defined as the upper side, and the opposite side as the lower side, This direction corresponds to the opening and closing direction of the switch.

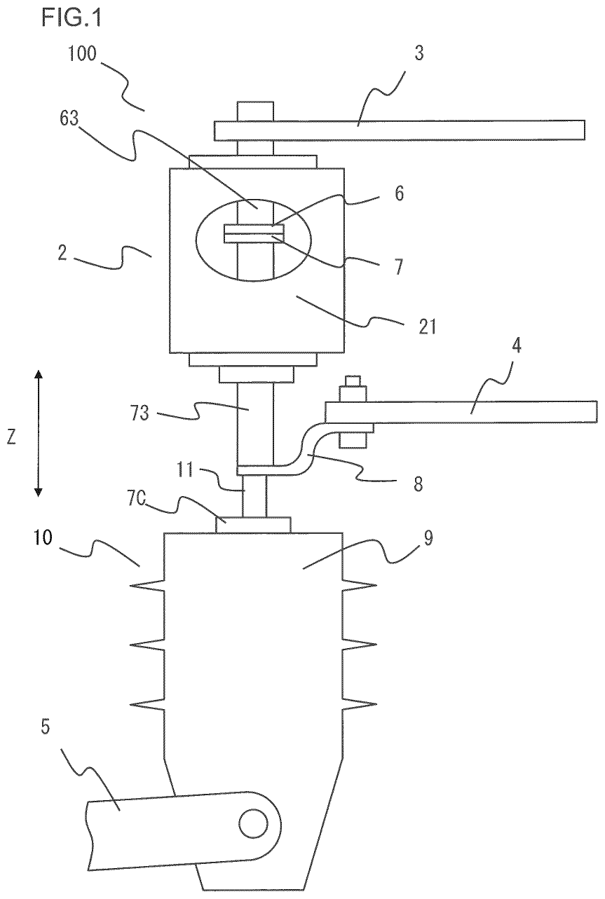

FIG. 1 is a schematic diagram showing the configuration of the main circuit portion of the switch 100 according to Embodiment 1.

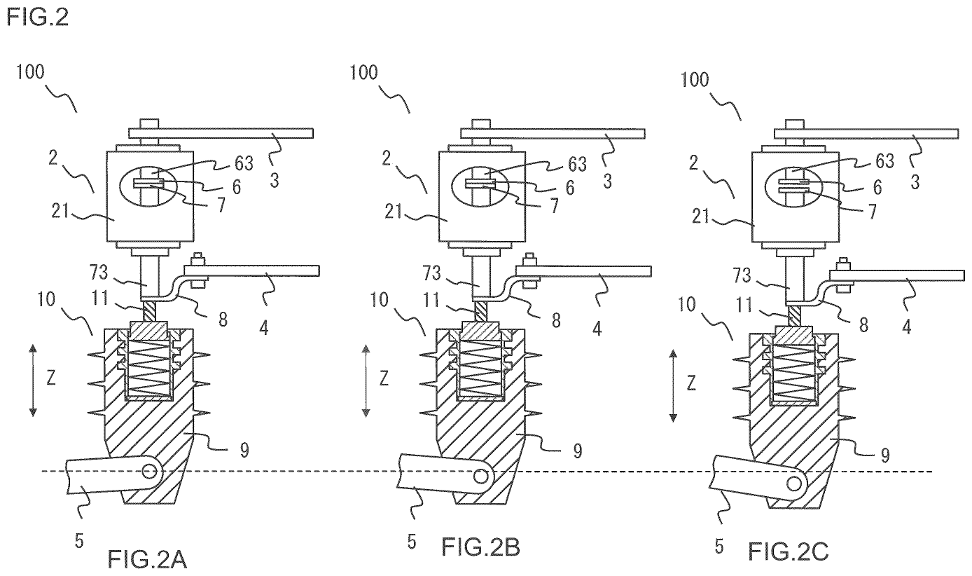

FIG. 2A is a schematic cross-sectional view of the switch 100 in the closed state.

FIG. 2B is a schematic cross-sectional view of the switch 100 at the moment the main contacts of the switch close or open.

FIG. 2C is a schematic cross-sectional view of the switch 100 in the open state.

FIGS. 2A to 2C illustrate the movement of the insulation rod 10 accompanying the operation of the switch 100.

To facilitate understanding of the internal structure of the insulation rod, the principal part of the insulation rod 10 in FIGS. 2A to 2C is shown as a cross-sectional view.

The switch 100 comprises a vacuum valve 2 and a switching mechanism 5 that performs an opening and closing operation of a fixed contact 6 and a movable contact 7, which are housed together in the vacuum valve 2 and have conductivity.

The vacuum valve 2 comprises an insulating container 21, the fixed contact 6, the movable contact 7, a fixed conductive shaft 63, and a movable conductive shaft 73. The insulating container 21 is a cylindrical container made of an insulating material, and its inside is hermetically sealed against outside air.

The fixed contact 6 is joined to a rod-shaped fixed conductive shaft 63 that penetrates from the inside to the outside of the insulating container 21. The movable contact 7 is arranged to face the fixed contact 6 and is connected to a rod-shaped movable conductive shaft 73 that also penetrates from the inside to the outside of the insulating container 21. Both the fixed conductive shaft 63 and the movable conductive shaft 73 have conductivity. The movable contact 7 can close contact with or open contact from the fixed contact 6.

Around the movable conductive shaft 73, a bellows (not shown) is disposed, ensuring that the inside of the vacuum valve 2 remains hermetically sealed in a vacuum state, even when the movable conductive shaft 73 moves in the axial direction Z. The vacuum valve 2, configured as described above, maintains the inside of the vacuum valve 2 in a vacuum state, while allowing the movable contact 7 to perform opening and closing operations with respect to the fixed contact 6. The end of the fixed conductive shaft 63 opposite the fixed contact 6 is connected to an upper terminal 3, while the movable conductive shaft 73 is connected to a lower terminal 4 via a flexible conductor 8.

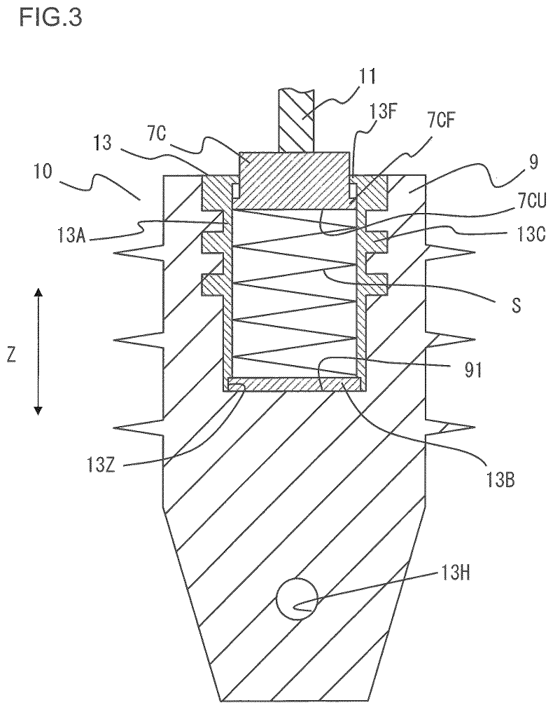

FIG. 3 is a cross-sectional view of a principal part of the insulation rod 10.

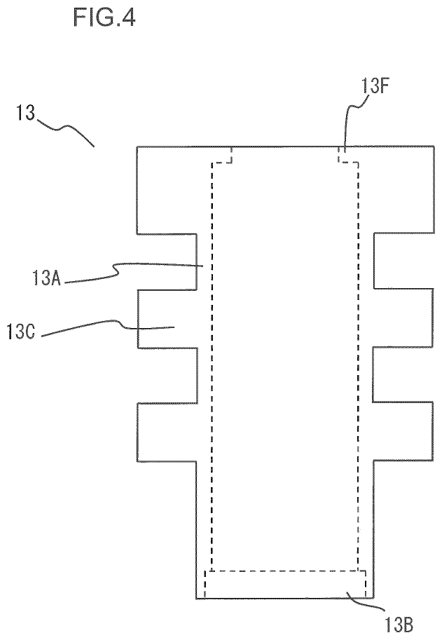

FIG. 4 is a schematic side view of the buried metal plate 13. The insulation rod 10 comprises a spring receiver 7C, a spring S, a buried metal plate 13, and an insulating portion 9. In other words, the insulation rod 10 is a part driven by the switching mechanism 5. The movable conductive shaft 73 of the vacuum valve 2 mentioned above and the spring receiver 7C of the insulation rod 10 are connected by a connecting rod 11.

The spring receiver 7C is cylindrical, and the lower end of the connecting rod 11 (shown in FIG. 2A, on the lower side of the page) is connected to the upper surface of the spring receiver 7C. The lower surface 7CU of the spring receiver 7C is in contact with the upper end of the spring S, while the lower end of the spring S is in contact with the bottom plate portion 13B of the buried metal plate 13, which will be described in detail later. The spring S is disposed in a compressed state between the spring receiver 7C and the bottom plate portion 13B of the buried metal plate 13, and it can expand and contract within the buried metal plate 13. The lower end of the spring receiver 7C has a flange portion 7CF (first flange portion) that protrudes outward. The flange portion 7CF is housed within the buried metal plate 13, allowing movement along the inner peripheral surface of the buried metal plate 13 in the axial direction Z within a predetermined range.

The buried metal plate 13 is made of metal and comprises a cylindrical main body portion 13A and a bottom plate portion 13B that seals the opening at the lower end of the main body portion 13A. When the main body portion 13A and the bottom plate portion 13B are combined, the buried metal plate 13 forms a bottomed cylinder. Additionally, the outer peripheral surface of the main body portion 13A is provided with an anchor portion 13C that protrudes outward in a flange shape or a spiral shape. Furthermore, the upper end of the inner peripheral surface of the main body portion 13A has a flange portion 13F (second flange portion) that protrudes inward. The outer peripheral surface of the buried metal plate 13 is covered with an insulating portion 9 that has electrical insulating properties.

The insulating portion 9 is molded by arranging the bottom plate portion 13B to be internally fitted and pressed into the recessed portion 13% (first recessed portion) provided on the inner side of the lower end of the main body portion 13A by molding pressure, and the structure ensures that no insulating material flows into the embedded metal plate 13 after the insulating portion 9 is molded. (Examples of methods for securing the arrangement include bolts, magnets, etc.)

The spring receiver 7C is movable in the axial direction Z along the inner peripheral surface of the cylindrical main body portion 13A of the buried metal plate 13. Here, the inner diameter of the flange portion 13F of the buried metal plate 13 is smaller than the outer diameter of the flange portion 7CF of the spring receiver 7C. Therefore, the flange portion 13F interferes with the flange portion 7CF, preventing the spring receiver 7C from entirely protruding out of the main body portion 13A of the buried metal plate 13 in the axial direction Z.

Next, the operation of the switch 100 will be described.

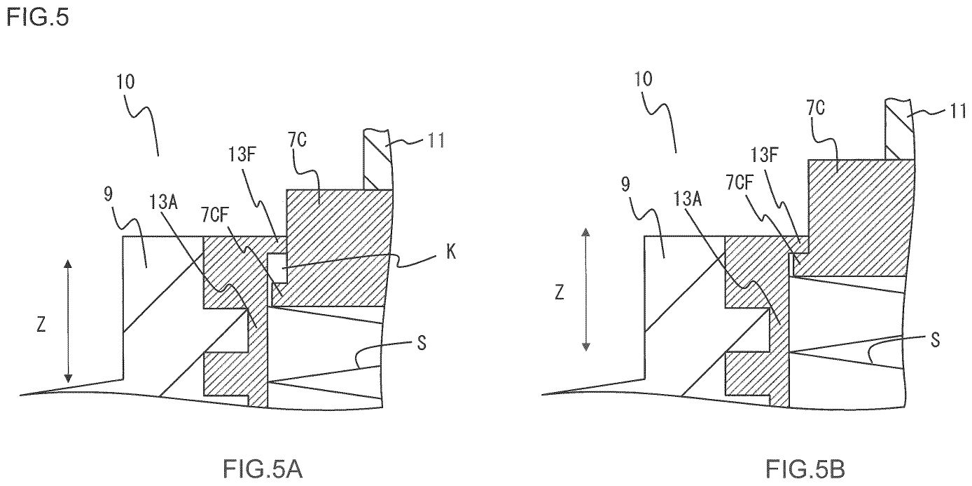

FIG. 5A is a cross-sectional view of a principal part of the insulation rod 10 in the closed state.

FIG. 5B is a cross-sectional view of a principal part of the insulation rod 10 in the open state.

To open the switch 100 from the closed state shown in FIG. 2A, the insulating portion 9 is pulled downward toward the bottom of the page in FIG. 3 by a pin (not shown) that is inserted through the driving pin hole 13H shown in FIG. 3. At this time, the space K shown in FIG. 5A that existed between the flange portion 13F of the buried metal plate 13 and the flange portion 7CF of the spring receiver 7C in the axial direction Z gradually becomes smaller, and the fixed contact 6 and the movable contact 7 reach the state shown in FIG. 2B while in abutment with each other.

Subsequently, the flange portion 7CF of the spring receiver 7C and the flange portion 13F of the buried metal plate 13 interfere, causing the entire insulation rod 10 to be pulled downward, and the movable contact 7 separates from the fixed contact 6, reaching the open state shown in FIG. 2C.

At this time, the spring S reaches its maximum length throughout the operation of the switch 100 within the buried metal plate 13, but its length is shorter than the natural length of the spring S. Accordingly, the insulation rod 10 is configured to ensure that the contact pressure exerted by the spring S on the spring receiver 7C does not disappear during the operation of the switch 100.

During the open state of the switch 100, the switch 100 is brought into the open state by pulling the movable conductive shaft 73 downward. Due to the resultant reaction force, a tensile load directed upward (toward the fixed contact side) in the axial direction Z is generated on the main body portion 13A of the buried metal plate 13. This load 1:0 is received by the anchor portion 13C provided on the outer peripheral surface of the main body portion 13A.

Conversely, in the reverse operation of the open state described above, the switch 100 transitions from the open state shown in FIG. 2C to the closed state shown in FIG. 2A. Specifically, during the closed state of the switch 100, the insulating portion 9 is pushed upward of the page in FIG. 3 by a pin (not shown) inserted through the driving pin hole 13H. The movable contact 7 gradually approaches the fixed contact 6, eventually reaching the state shown in FIG. 2B. Furthermore, as the insulating portion 9 is pushed upward, the sequentially connected movable contact 7, movable conductive shaft 73, connecting rod 11, and spring receiver 7C cannot rise further, resulting in the gradual compression of the spring S.

Then, due to the repulsive force of the spring S, the movable contact 7 is pressed against the fixed contact 6, resulting in the closed state. At this time, a space K is formed between the flange portion 7CF of the spring receiver 7C and the flange portion 13F of the buried metal plate 13 in the axial direction Z.

In the closed state of the switch 100, contact pressure is applied to the movable contact 7 in the direction toward the fixed contact 6 by the spring S, At the same time, a similar contact pressure is generated in the opposite direction of the spring S, and this force is received by the bottom plate portion 13B of the buried metal plate 13. Since the main body portion 13A and the bottom plate portion 13B are independent of each other, the bottom plate portion 13B presses its lower surface against the insulating portion 9 with which it is in contact. As a result, the contact surface 91 between the bottom plate portion 13B and the insulating portion 9, as shown in FIG. 3, is stabilized, and the formation of minute gaps between the bottom plate portion 13B and the insulating portion 9 is suppressed.

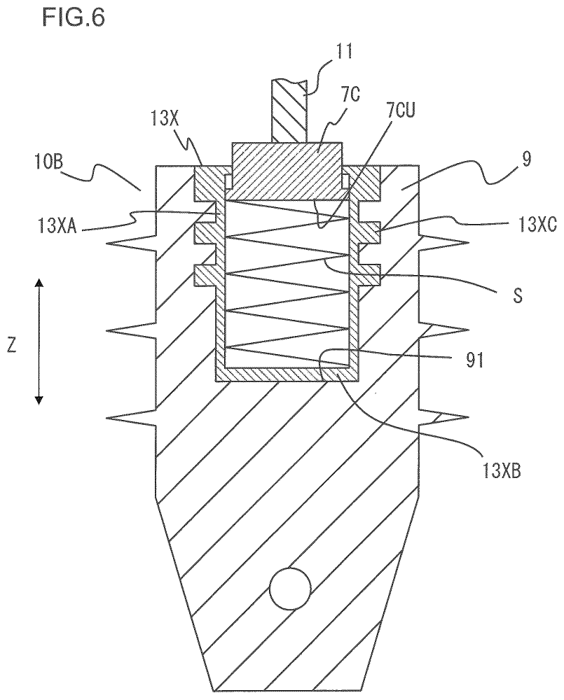

FIG. 6 is a cross-sectional view of a principal part of the insulation rod 10B as a comparative example. The buried metal plate 13X that holds the spring receiver 7C has a cup-shaped structure, and its main body portion 13XA and bottom portion 13XB are integrally formed. When such a buried metal plate 13X is used in the switch, during the opening operation of the switch described above, the buried metal plate 13X is pulled upward in the axial direction Z due to the resultant reaction force caused by the opening operation. This force is received by the anchor portion 13XC provided on the outer peripheral surface of the main body portion 13XA of the buried metal plate 13X.

During the closing operation, the insulating rod 10B is pushed upward by a pin, compressing the spring S while driving it. The buried metal plate 13X receives the load from the spring S at its bottom portion 13XB. Since the main body portion 13XA and the bottom portion 13XB of the buried metal plate 13X are integrated, the load on the bottom portion 13XB acts as a stretching force in the axial direction Z on the main body portion 13XA. As a result, the load is confined within the buried metal plate 13X, and no load is generated to insulating portion 9 in contact with the bottom portion 13XB to stabilize the contact surface 91 between the buried metal plate 13X.

On the other hand, when the switch 100 according to Embodiment 1 is in the open state, by the operation of the insulation rod 10, the spring S extends further compared to the closed state. However, as described above, without losing all contact pressure, forces remain present, and the spring S continues to press against the bottom plate portion 13B. Thus, as in the closed state, the load generated by the spring S stabilizes the contact surface 91, suppressing the occurrence of minute gaps between the insulating portion 9 and the bottom plate portion 13B.

In the comparative example, the load generated by the spring S was contained entirely within the buried metal plate 13X. However, in Embodiment 1, regarding the structural strength concerns about the load from the spring S affecting the insulating portion 9, the issue can be resolved if the bottom plate portion 13B has a seating surface that can sufficiently reduce the surface pressure against the strength of the insulating portion 9. Additionally, for the edges of the main body portion 13A and the bottom plate portion 13B, processing should ensure no burrs or no sharp edges are allowed, thereby preventing stress concentration.

According to the insulation rod 10 and the switch 100 of Embodiment 1, the buried metal plate 13 is composed of two separate components: the main body portion 13A and the bottom plate portion 13B. Consequently, in both the closed and open states of the switch 100, the bottom plate portion 13B of the buried metal plate 13 is pressed against the insulating portion 9. This ensures the stabilization of the contact surface 91 between the bottom plate portion 13B and the insulating portion 9 and suppresses the formation of minute gaps due to wear on the insulating portion 9. Additionally, it improves the electrical performance of the insulation rod.

Furthermore, conventional measures to prevent the formation of minute gaps, such as increasing the dimension between the buried metal plate and the grounding point to ensure the insulation distance or applying conductive paint, are no longer necessary. This leads to enhanced manufacturing workability and cost reduction.

In the comparative example, the buried metal plate 13X is manufactured by hollowing out a blind hole 13Xh through machining. However, in the buried metal plate 13 according to this embodiment, the main body portion 13A is provided with a through-hole 13h, thereby improving the machinability of the buried metal plate 13. Furthermore, during surface treatment, the occurrence of plating liquid pooling is eliminated, resulting in an improved product quality. Additionally, while the buried metal plate 13X in the comparative example was manufactured from bar stock, the buried metal plate 13 in this embodiment can be manufactured from pipe material, enabling cost reduction in processing and efficient use of materials.

### Embodiment 2

An insulation rod and a switch according to Embodiment 2 will be described below, focusing on the differences from Embodiment 1.

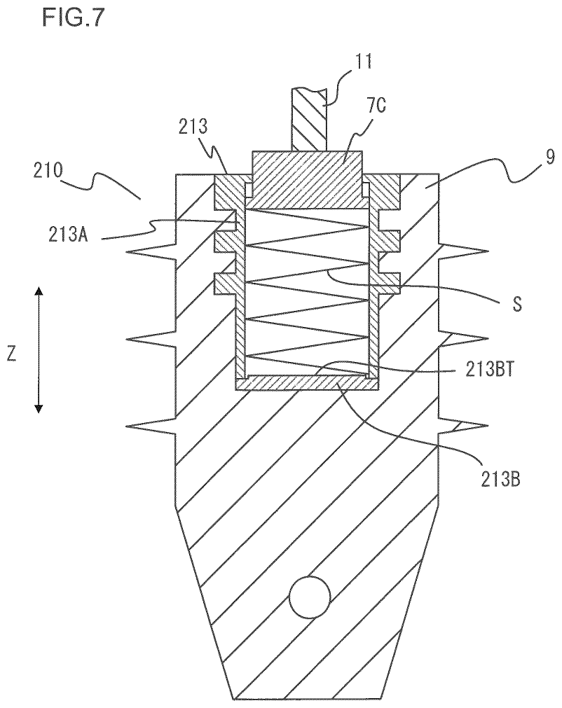

FIG. 7 is a cross-sectional view of a principal part of the insulation rod 210.

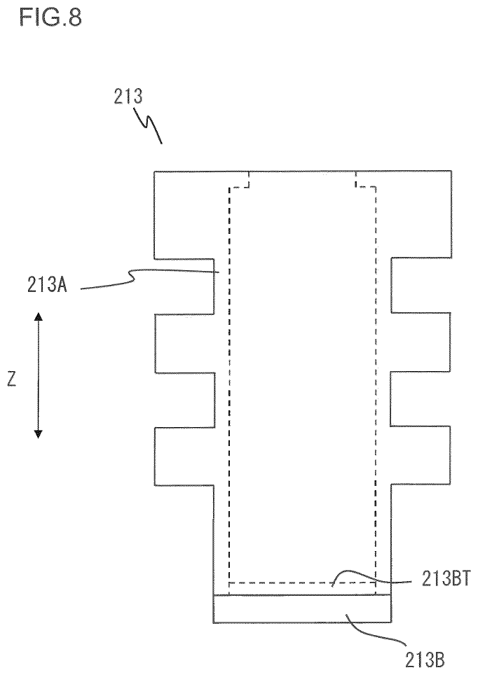

FIG. 8 is a schematic side view of the buried metal plate 213.

The buried metal plate 213 has been modified from Embodiment 1 to adopt a structure that integrates the buried metal plate and prevents insulating material from flowing into the inside of the buried metal plate under the molding pressure applied during the formation of the insulating portion 9. In this Embodiment 2, instead of providing a recessed portion on the main body portion 213A, a protrusion 213BT projecting upward is formed on the upper surface of the bottom plate portion 213B. The protrusion 213BT is internally fitted to the lower end of the main body portion 213A in the axial direction Z, functioning as a plug.

During the opening and closing operations of the switch 100, the insulating rod 210 operates in the same manner as described in Embodiment 1. Consequently, the forces acting on the buried metal plate 213 of the insulating rod 210 due to the opening and closing operations of the switch 100 are identical to those described in Embodiment 1. As a result, the bottom plate portion 213B, like the bottom plate portion 13B in Embodiment 1, is pressed against the insulating portion 9 regardless of the switch's open or closed state.

The insulating rod and switch according to Embodiment 2 achieve the same effects as those of Embodiment 1.

### Embodiment 3

An insulation rod and a switch according to Embodiment 3 will be described below, focusing on the differences from Embodiment 2.

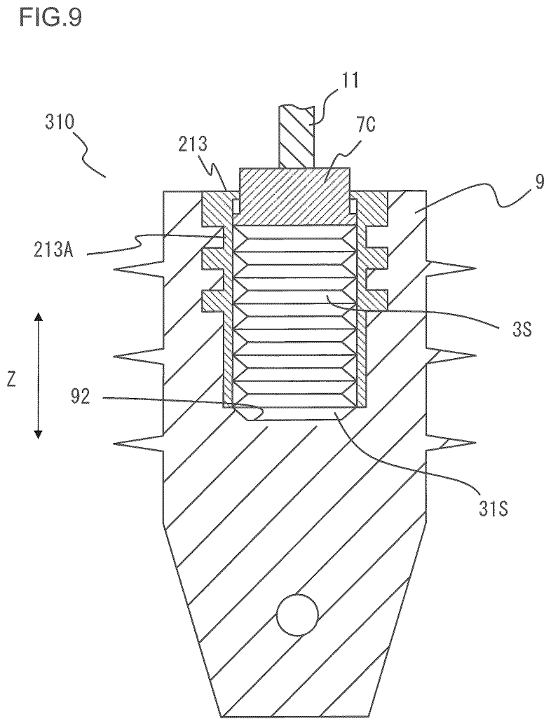

FIG. 9 is a cross-sectional view of a principal portion of the insulating rod 310.

In this Embodiment 3, the bottom plate portion 213B of the buried metal plate 213 described in Embodiment 2 is eliminated, and only the main body portion 213A remains. Additionally, the spring 3S consists of a stack of disc springs 318, and the insulating portion 9 is provided with a recessed portion 92 (second recessed portion) whose shape corresponds to the natural length (uncompressed state) of the lowermost disc spring 31S. The lowermost disc spring 31S serves as a substitute for the bottom plate portions 13B and 213B described in Embodiments 1 and 2.

During the opening and closing operations of the switch 100, the insulating rod 310 operates in the same manner as described in Embodiment 2. Consequently, the forces acting on the buried metal plate of the insulating rod 310 due to the opening and closing operations of the switch 100 are identical to those described in Embodiment 2. However, since the bottom plate portion 213B has been eliminated, the forces that were previously borne by the bottom plate portion 213B in Embodiment 2 are now borne by the lowermost disc spring 31S in the spring 3S.

In Embodiment 2, the bottom plate portion 213B was pressed against the insulating portion 9 by the opening and closing operations of the switch 100. However, in Embodiment 3, the lowermost disc spring 315 is pressed against the insulating portion 9. The disc spring 31S tends to expand beyond its natural length in a direction perpendicular to the axial direction Z. However, since the diameter of the recessed portion 92 of the insulating portion 9 in contact with the disc spring 31S matches the natural length diameter of the disc spring 31S, it cannot expand further. As a result, the disc spring 31 remains in close contact with the insulating portion 9 and the recessed portion 92, stabilizing the contact surface.

According to the insulating rod and switch of Embodiment 3, by adjusting the switch 100 and the insulating rod 310 so that the impact during the opening and closing operations of the switch 100 applies a load that does not cause damage or creep to the insulating portion 9, it is possible to prevent the formation of minute gaps between the insulating portion 9 and the lowermost disc spring 31S. As a result, the electrical performance of the insulating rod 310 and the switch 100 can be improved.

Although the disclosure is described above in terms of various exemplary embodiments and implementations, it should be understood that the various features, aspects, and functionality described in one or more of the individual embodiments are not limited in their applicability to the particular embodiment with which they are described, but they can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

100 Switch
10, 10B, 210, 310 Insulating rod
11 Connecting rod 13, 13X, 213 Buried metal plate
13A, 213A, 13XA Main body portion
13B, 213B Bottom plate portion
13XB Bottom portion
13C, 13XC Anchor portion
13F, 7CF Flange portion
213BT Protrusion
13h Through-hole
13H Driving pin hole
13Xh Blind hole
13Z Recessed portion
2 Vacuum valve
21 Insulating container
3 Upper terminal
S, 3S Spring
31S Disc spring
4 Lower terminal
5 Switching mechanism
6 Fixed contact
63 Fixed conducting shaft
7 Movable contact
73 Movable conducting shaft
7C Spring receiver
7CU Lower surface
8 Conductor
9 Insulating portion
91 Contact surface
K Space
Z Axial direction

1. An insulation rod comprising:
a spring receiver;
a buried metal plate in the form of a bottomed cylinder with an open upper end, the buried metal plate accommodating the spring receiver so as to allow movement within a predetermined range along the inner peripheral surface of the buried metal plate; and
an insulating portion that electrically insulates the outer peripheral surface of the buried metal plate, wherein
a bottom plate portion of the buried metal plate and a body portion of the buried metal plate are configured as separate bodies, and
a compressed spring is provided between a lower surface of the spring receiver and the bottom plate portion of the buried metal plate.

2. The insulation rod according to claim 1, wherein
the spring receiver includes a first flange portion protruding outward on an outer peripheral surface of the lower end thereof, the buried metal plate includes a second flange portion protruding inward on an inner peripheral surface of the upper end thereof, and
the inner diameter of the second flange portion of the buried metal plate is smaller than the outer diameter of the first flange portion of the spring receiver, such that the first flange portion is housed inside the buried metal plate.

3. The insulation rod according to claim 1, wherein
the buried metal plate includes a flange-shaped or helical anchor portion protruding outward from the outer peripheral surface thereof.

4. The insulation rod according to claim 1, wherein
the body portion of the buried metal plate is cylindrical, and the bottom plate portion of the buried metal plate is internally fitted into a first recessed portion provided at a lower end of the inner peripheral surface of the body portion.

5. The insulation rod according to claim 1, wherein
the body portion of the buried metal plate is cylindrical, the bottom plate portion of the buried metal plate includes a protrusion extending upward at the center, and the protrusion is internally fitted into a lower end of the inner peripheral surface of the body portion.

6. An insulation rod comprising:
a spring receiver;
a buried metal plate in the form of a bottomed cylinder with an open upper end, the buried metal plate accommodating the spring receiver so as to allow movement within a predetermined range along the inner peripheral surface of the buried metal plate; and
an insulating portion that electrically insulates the outer peripheral surface of the buried metal plate, wherein
a plurality of compressed disc springs are provided between a lower surface of the spring receiver and an upper surface of the insulating portion that seals a lower end of an internal cavity of the buried metal plate, and the upper surface of the insulating portion includes a second recessed portion having the same shape as the disc springs when in an uncompressed state.

7. The insulation rod according to claim 6, wherein
the spring receiver includes a first flange portion protruding outward on an outer peripheral surface of the lower end thereof, the buried metal plate includes a second flange portion protruding inward on an inner peripheral surface of the upper end thereof, and
the inner diameter of the second flange portion of the buried metal plate is smaller than the outer diameter of the first flange portion of the spring receiver, such that the first flange portion is housed inside the buried metal plate.

8. The insulation rod according to claim 6, wherein
the buried metal plate includes a flange-shaped or helical anchor portion protruding outward from the outer peripheral surface thereof.

9. A switch comprising the insulation rod according to claim 1.

10. The insulation rod according to claim 2, wherein
the buried metal plate includes a flange-shaped or helical anchor portion protruding outward from the outer peripheral surface thereof.

11. The insulation rod according to claim 2, wherein
the body portion of the buried metal plate is cylindrical, and the bottom plate portion of the buried metal plate is internally fitted into a first recessed portion provided at a lower end of the inner peripheral surface of the body portion.

12. The insulation rod according to claim 3, wherein
the body portion of the buried metal plate is cylindrical, and the bottom plate portion of the buried metal plate is internally fitted into a first recessed portion provided at a lower end of the inner peripheral surface of the body portion.

13. The insulation rod according to claim 2, wherein
the body portion of the buried metal plate is cylindrical, the bottom plate portion of the buried metal plate includes a protrusion extending upward at the center, and the protrusion is internally fitted into a lower end of the inner peripheral surface of the body portion.

14. The insulation rod according to claim 3, wherein
the body portion of the buried metal plate is cylindrical, the bottom plate portion of the buried metal plate includes a protrusion extending upward at the center, and the protrusion is internally fitted into a lower end of the inner peripheral surface of the body portion.

15. The insulation rod according to claim 7, wherein
the buried metal plate includes a flange-shaped or helical anchor portion protruding outward from the outer peripheral surface thereof.

16. A switch comprising the insulation rod according to claim 2.

17. A switch comprising the insulation rod according to claim 3.

18. A switch comprising the insulation rod according to claim 6.

19. A switch comprising the insulation rod according to claim 7.

20. A switch comprising the insulation rod according to claim 8.
